(19) United States
(12) Patent Application Publication
(10) Pub. No.: US 2025/0084693 A1
(43) Pub. Date: Mar. 13, 2025

(54) TIGHT-COIL ROLLING GRILLE

(71) Applicant: Lawrence Roll-Up Doors, Inc., Baldwin Park, CA (US)

(72) Inventors: Steven Hahn, Brentwood, CA (US); Paul Freberg, La Canada, CA (US); Paul Lawrence, Monrovia, CA (US)

(21) Appl. No.: 18/826,869

(22) Filed: Sep. 6, 2024

Related U.S. Application Data
(60) Provisional application No. 63/582,465, filed on Sep. 13, 2023.

(51) Int. Cl. E06B 9/18; E06B 9/68; E06B 9/70

(52) U.S. Cl. CPC E06B 9/18; E06B 9/70; E06B 2009/6836

(57) ABSTRACT

A tight-coiling rolling grille link and rolling grille system. Curved links are interconnected in vertical rows for a required height of the grille, rows are spaced apart for a required width of the grille, horizontal rods are inserted through aligned holes in the links, tubes are placed intermittently over the rods between the rows of links to maintain even spacing, and ends of the rods are mechanically secured to hold the rolling grille curtain together. The links of the grille are identical and are attached symmetrically via a tab and notch linkage scheme. The system prioritizes coiling as tightly as possible to fit in as little space above the opening as possible.

### CROSS-REFERENCE TO RELATED APPLICATION

The application claims priority to U.S. Provisional Pat. App. No. 63/582,465 filed Sep. 13, 2023, titled Tight-Coil Rolling Grille, and is hereby incorporated by reference in its entirety.

### FIELD OF THE INVENTION

The present invention relates to the field of rolling grilles/barriers.

### BACKGROUND OF THE INVENTION

Rolling grilles are typically used to cover a building opening to prevent the passage of objects, vehicles, people, or elements through the opening. Rolling grilles are formed, in general, of a curtain of links and rods which are pivotally connected end to end. Thus, the links may be rolled up around a suitable hub or axle or, alternatively, rolled down to form an articulated curtain. Such grilles are normally mounted on a door or window opening. Thus, the grilles are either rolled up above the opening, out of the way, or extended downward into the curtain formation to cover the opening.

Common uses for such rolling grilles usually include providing a barrier for an opening of varying shapes that can easily be held open without requiring swing or slide space for a door.

### BRIEF DESCRIPTION OF THE DRAWINGS

FIG. 1 is a set of perspective views of a tight-coil grille link.

FIG. 2 is a side view of an embodiment of a tight-coil grille link.

FIG. 3 is a coiled view of a tight-coil grille curtain.

FIG. 4 is a front view of an installed grille curtain.

FIG. 5 is a depiction of a mounting guide associated with a tight-coil grille curtain.

FIG. 6 is a depiction of a series of tight-coil grille links connected in a symmetrical linkage as compared to a conventional asymmetrical linkage.

FIG. 7 is a depiction of an embodiment of the uniformly sized symmetrical tight-coil grille links compared to conventional variably sized asymmetrical links.

### DETAILED DESCRIPTION

Disclosed herein is a tight-coiling grille link and rolling grille system. The links are interconnected in vertical rows for the required height of the grille, rows are spaced apart (ex: less than 9 inches or greater than 9 inches) for the required width of the grille, horizontal rods are inserted through aligned holes in the links, tubes are placed intermittently over the rods between the rows of links to maintain even spacing, and the ends of the rods are mechanically secured, such as with pins, to hold the rolling grille curtain together.

The tight-coil link is part of a rolling grille assembly, prioritizing coiling as tightly as possible to fit in as little space above the opening (headroom) as possible. An example of a common application is in a commercial/multifamily parking garage where a minimum 8-foot, 2-inch clear opening height is required for compliance with the accessibility guidelines of the Americans with Disabilities Act, but the building design has not allowed enough headroom for a traditional rolling grille—typically requiring 18 inches or more of headroom—to fit.

An object of the present invention is to provide for a rolling grille which is compact and efficient. An additional object of the present invention is to provide functions commonly associated with existing rolling grilles simultaneously with newly invented functions.

Example materials include extruded, machined, cast, or 3D-printed metals, such as aluminum. Variations upon the tight-coil link and rolling grille system include differing configurations of dimensions of the link including: link shape or curvature (radius), how the links fit together top and bottom, or alternatively how they can be assembled separately into patterns, material and finish, method of forming, spacing of links in the curtain assembly, the manner in which the links are spaced apart, the type of rods used to connect the links together, and how the ends of the rods are secured. Desired materials for the core material may vary based on desired functions and cost.

It is to be understood that this invention is not limited to particular aspects of the present invention described, and as such may, of course, vary. It is also to be understood that the terminology used herein is for the purpose of describing particular aspects only, and is not intended to be limiting, since the scope of the present invention will be limited only by the appended claims.

Unless expressly defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

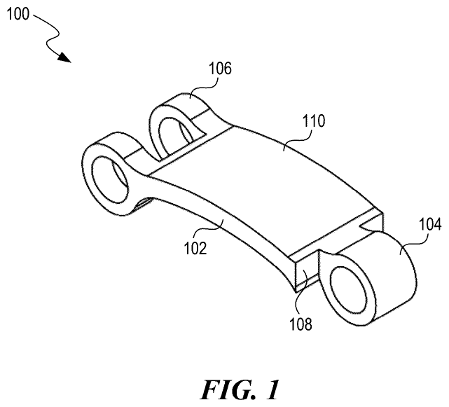

FIG. 1 is a perspective view of a tight-coil grille link 100. The link 100 includes an arched length 102, a tab linkage 104, and a notch linkage 106. The tab linkage 104 is a singular tubular piece attached to the center of the shoulders 108 on the linkage body 110. The notch linkage 106 is two separate tubular pieces positioned on the end opposite shoulder 108. A gap separates the separate tubular pieces of notch linkage 106. The tab linkage 104 fits into the notch linkage 106 of a different, substantially similar link 100 with minimal clearance while still exhibiting smooth articulation. A rod (not shown) is inserted through a tab linkage 104 of a first link 100 and the notch linkage 106 of a second link 100 to secure the two linkages together. The inserted rod is similarly configured with minimal clearance while still exhibiting smooth articulation.

In some embodiments, the arched length 102 is extended, and a curvature is adjusted to compensate. Alternatively, shorter links (and additional articulation points) improve the tightness of a resulting grille coil but increase the overall cost by increasing the number of links required as well as the number of rods inserted therebetween. Additional rods increase the overall weight of the grille curtain, which may lead to requiring a more powerful retraction mechanism/motor. The tab and notch design is a laterally stable configuration, is symmetrical, and enables weight from links 100 higher in a grille curtain to commonly rest on shoulders 108 of lower links 100 when the curtain is extended.

Conventional systems are more complicated and costly. Specifically, conventional systems can only enable tight coiling by, for example, varying the size of the links and securing them asymmetrically, which adds complication to scale production. Assembly of conventional tight coiling grille curtains is also more time-consuming based upon the added complexity caused by the different sized links—i.e., putting the right parts in the right places. Additionally, the asymmetry also leads to increased complexity when a repair occurs.

The conventional asymmetrical designs require spacer tubes between every link on every rod or other means to physically separate and maintain alignment of the links. Conversely, the present technology reduces the number of spaces, for example, by only utilizing spacers every sixth rod due to the self-aligning characteristics of the link 100. The larger links (of varied sizes) create increasingly more open spacing between the rods, which is potentially a safety and security hazard because a person could more easily reach through the spacing. Conversely, the present technology provides a consistent spacing between rods that complies with industry standards for automated rolling grilles.

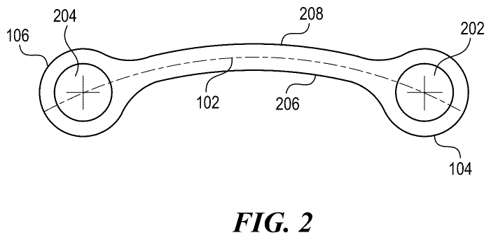

FIG. 2 is a side view of an embodiment of a link 100. The link 100 is symmetrical when viewed from the side, allowing a rod (not shown) to connect multiple links 100 of the same size. Link 100 includes tab linkage 104, tab rod hole 202, notch linkage 106, notch rod hole 204, and arched length 102. Tab rod hole 202 and notch rod hole 204 have the same diameter to accommodate the same dimensioned rod when linked together. For example, tab rod hole 202 and notch rod hole 204 can have a diameter greater than the rod, allowing the link 100 to rotate on the rod while in a tight-coil curtain position. Arched length 102 connects tab linkage 104 and notch linkage 106. Arched length 102 is defined by upper radius 208 and lower radius 206. The upper radius 208 and lower radius 206 define the thickness of the arched length and can contribute to the tightness of the links 100, which can be coiled together. For example, a larger or smaller radius of the upper radius 208 and lower radius 206 or a greater or smaller distance between the tab rod hole 202 and notch rod hole 204 affects the coil radius of the links when in a tight-coil curtain configuration.

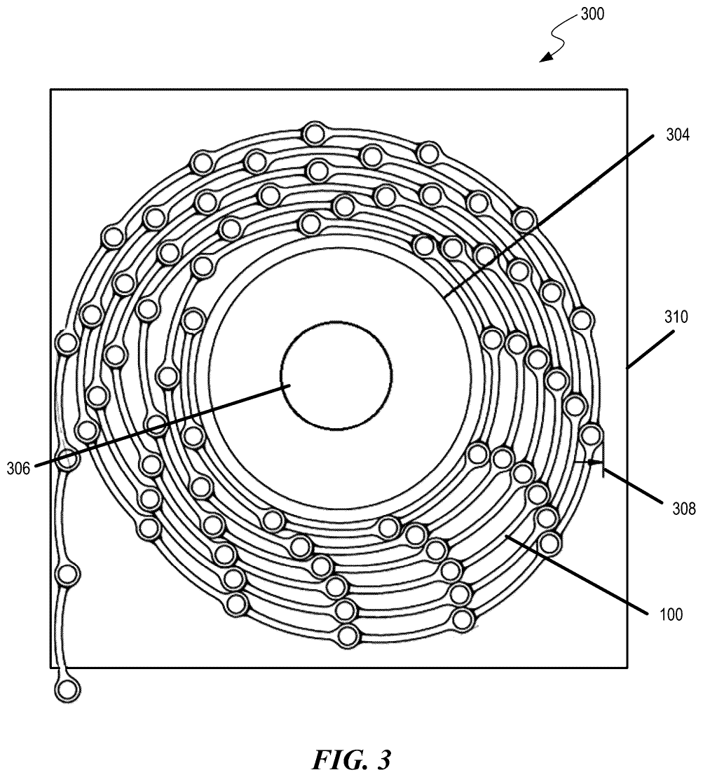

FIG. 3 is a coiled view of a tight-coil grille curtain 300. A link coil 100 wraps around a barrel 304 with a central axle 306. The curvature of individual links 100 enables a tighter coil than otherwise available and reduces the size of the barrel 304. The barrel 304 is sized to allow minimal clearance 308 between the link coil 100 and the perimeter of the curtain mounting brackets 310 while still exhibiting smooth extension and retraction.

In some embodiments, barrel 304 is a steel pipe with a diameter of at least 4½ inches and constructed of schedule 40 steel piping. The barrel 304 supports the curtain with a maximum deflection of 0.03 inches per foot of width. Axles, which can be steel shafts with a 1½-inch diameter, are used to support each end of the barrel 304.

An example of mounting brackets includes ¼-inch minimum steel plates bolted to wall angles. Plates are sized to support the curtain and barrel and are provided with flanges for hood attachment. Brackets are fitted with self-aligning bearings.

In some embodiments, a hood is formed from sheet metal with top and bottom reinforcements to reduce deflection.

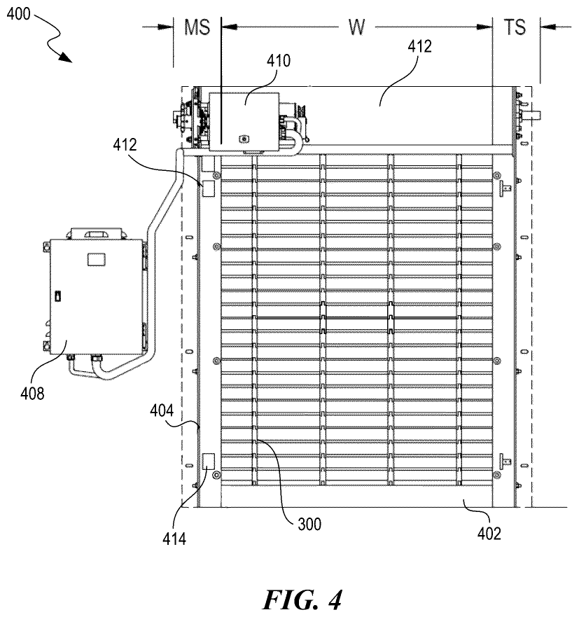

FIG. 4 is a front view of an installed rolling grille system 400. The installed rolling grille system 400 includes the curtain 300, bottom bar 402, guide 404, and motor 410. Bottom bar 402 is attached to the end of curtain 300 to keep the curtain 300 taught along the horizontal bottom end of the curtain 300. The guide 404 is configured to retain the curtain 300 to the vertical sides of curtain 300 and guide the curtain 300 from an extended or down position to a rolled or coiled position and vice versa when the motor 410 is activated.

In some embodiments, the rolling grille system 400 further includes a sensing system, including a monitored photo eye 414 to stop and reverse a closing curtain 300 upon sensing an obstruction in the opening. Further included is a secondary monitored light curtain to stop and reverse a closing curtain 300 and a secondary photo eye 412 at the top of the guides to stop an opening curtain 300 upon sensing an obstruction in the opening. Logic programmed into the sensor system responds to a fault detected by the curtain 300, causing the curtain 300 to stay in or return to an open position and revert to a constant pressure close function for partial operability until the fault is corrected. In some embodiments, the sensing system includes a monitored sensing edge to stop and reverse a closing curtain 300 upon contact with an obstruction. The sensing system uses a rubber dual-chamber profile design with integral isolated conductive elastomer switches (which increases standard headroom by 1½ inches).

The motor system 410 that drives the opening and closing of the curtain 300 includes a high-efficiency inline gear drive motor operator. A motor 410 with a minimum 2 horsepower rated for continuous duty operates on 208/230 v-3 ph or 460 v-3 ph power source (2 horsepower available as 230 v-1 ph). An auxiliary hoist is included for emergency hand chain operation during a power failure. In some embodiments, the motor 410 includes an integral speed governor to prevent curtain free-fall in the event of operator component failure. In some other embodiments, the motor 410 is configured for variable speed control with an adjustable soft start/stop feature. For example, the motor 410 can be configured for an average operating speed of approximately 24 inches per second to open and 12 inches per second to close—slowing prior to full open and full close. In some embodiments, the motor system 410 further includes a solenoid actuated brake, adjustable limit switches, a non-resettable cycle counter, and an adjustable reclose timer with delay on reverse. An auxiliary transformer is included to support supplemental sensors and ancillary control devices.

In some embodiments, the installed rolling grille system 400 is operated by a wall-mount control panel 408 connected to the motor 410 via a pre-assembled wiring harness. The control panel 408 can be mounted directly next to the installed grille curtain 400 or at a distance away from the rolling grille system 400. It controls the operation of the installed rolling grille system 400, i.e., opening or closing the curtain 300.

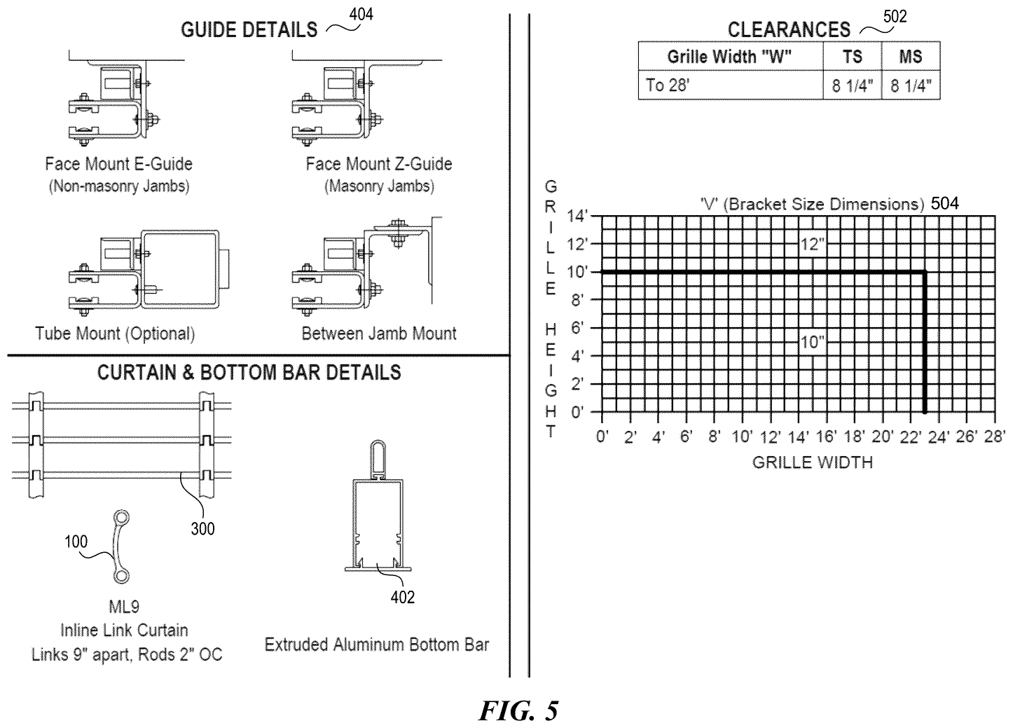

FIG. 5 is a depiction of a mounting guide associated with a tight-coil grille curtain 300. The rolling grille curtain 300 is configured to prioritize operational performance (repetition of operation and efficiency thereof) and low headroom. In some embodiments, the rolling grille curtain 300 is constructed with a springless design for 500,000 cycles of usage and an average operating speed of 24 inches per second to open and 12 inches per second to close. Further, the tight coil links 100 enable a reduced overhead footprint and may be installed to fit in small spaces. Other embodiments of the rolling grille curtain 300 utilizes materials and equipment appropriately suited for lesser performance.

A number of exemplary dimensions are provided below. These dimensions are intended as illustrative and not limiting. In some embodiments, the dimensions scale on a 1-to-1 basis; however, in some instances, the dimensions do not directly scale. Sizes up to 23 feet wide and up to 10 feet high need only 1 foot of clearance 502 above the opening. Larger curtain sizes (28 feet wide by up to 14 feet high) require only an additional 2 inches of upper clearance 502.

Example sizes of the repeating pattern of the inline grille curtain 300 include 13/16-inch-wide, 5/32-inch-thick, 2-hole curved aluminum links 8¾ inches apart, interconnected with 5/16-inch solid aluminum horizontal rods on 2-inch centers. The curtain 300 is constructed with spacer tubes (not shown) between curtain end links 100 on every rod (not shown) (e.g., made of stainless steel) and spacer tubes between all other links on every sixth rod (e.g., made of aluminum). The choices of example materials balance strength with the weight of the curtain 300. In some embodiments, the curtain 300 implements a straight link pattern. Curtain alignment is maintained by stainless steel spacer tubes placed between end links 100 on every rod (also reducing curtain wear) and aluminum spacer tubes placed between all other links on every sixth rod. The ends of the rods are drilled and secured with cotter pins. The curtain pattern provides approximately 76% open area through the curtain 300.

The rolling grille curtain 300 is constructed with a bottom bar 402. In some embodiments, the bottom bar 402 construction is a rectangular aluminum extrusion attached to the bottom of the curtain and internally reinforced to limit vertical and lateral deflection. The bottom bar 402 acts as a rolling grille curtain 300 stiffener. On either side of the curtain 300 are guides 404 fabricated from 3/16-inch-thick steel U-channels with replaceable extruded UHMW wear strips bolted to ¼-inch-thick steel wall angles. The barrel is of a springless design with a 4½-inch-diameter schedule 40 pipe and 1½-inch shafts.

In some embodiments, guides 404 shall be assembled with ⅜-inch minimum bolts no more than 24 inches on center and attached to the wall with ½-inch minimum bolts no more than 24 inches on center. In some embodiments, guides 404 are provided with continuous isolation strips to reduce vibration and noise transmitted from the curtain 300 to the structure.

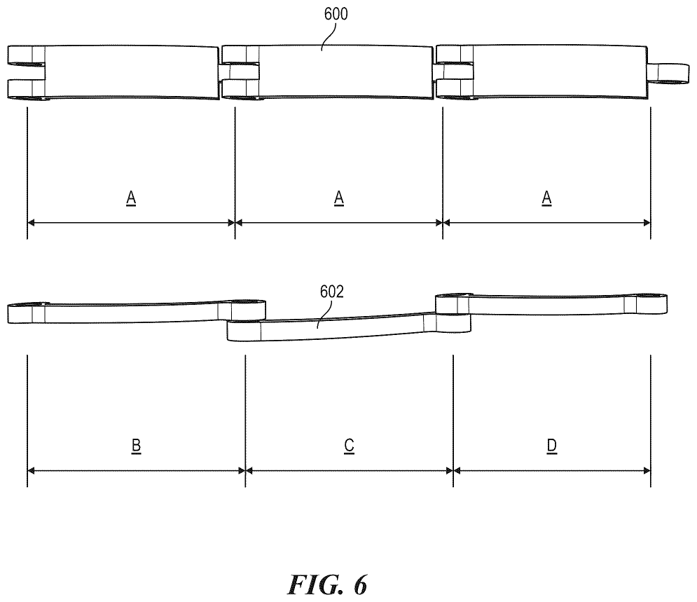

FIG. 6 is a depiction of a series of tight-coil grille links connected in a symmetrical linkage as compared to a conventional asymmetrical linkage. The figure depicts an embodiment of the present linkage 600 as well as a conventional linkage 602. Notably, the present linkage 600 is a symmetrical linkage that connects in the same fashion between each link. The conventional linkage 602 uses varied-length links (which are depicted in descending length order from left to right) and uses an alternating scheme for mounting sides. Both of these issues (e.g., varied length and asymmetrical linkage) contribute to assembly, repair, and cost-efficiency issues. Further, the side-by-side configuration is more susceptible to applied torque than the tab and notch linkage of the present linkage 600.

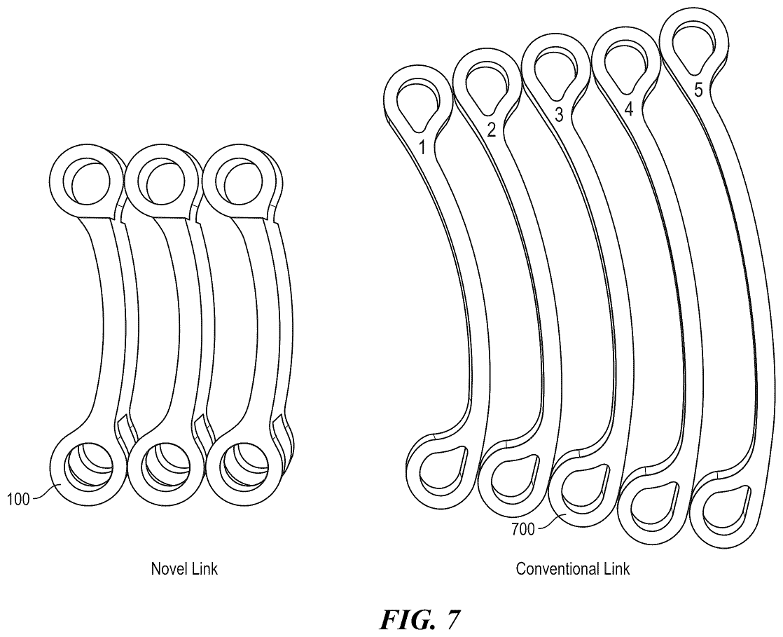

FIG. 7 is a depiction of uniformly sized symmetrical tight-coil grille links 100 compared to variably sized asymmetrical links 700. The figure depicts another representation of conventional links 700 having a varied length (this time from the shortest on the left). In practice there are seven link lengths in the conventional system, though only five are depicted. In contrast, the disclosed tight-coil grille links 100 are each identical and connect to one another in a symmetrical linkage.

The foregoing disclosures and statements are illustrative only of the present invention and are not intended to limit or define the scope of the present invention. The above description is intended to be illustrative, and not restrictive. Although the examples given include many specifics, they are intended as illustrative of only certain possible applications of the present invention. The examples given should only be interpreted as illustrations of some of the applications of the present invention, and the full scope of the present invention should be determined by the appended claims and their legal equivalents. Those skilled in the art will appreciate that various adaptations and modifications of the just-described applications can be configured without departing from the scope and spirit of the present invention. Therefore, it is to be understood that the present invention may be practiced other than as specifically described herein. The scope of the present invention as disclosed and claimed should, therefore, be determined with reference to the knowledge of one skilled in the art and in light of the disclosures presented above.

We claim:

1. A rolling grille system comprising:
a plurality of curved links, each curved link affixed to an adjacent curved link through a plurality of rods, thereby forming a rolling curtain,
wherein each curved link has substantially similar dimensions, and
wherein the curved links cause the rolling curtain to have uniform gaps between each curved link;
a bottom bar attached to a bottom end of the rolling curtain,
wherein the bottom bar is configured to add horizontal rigidity to the rolling curtain;
a barrel configured to receive the rolling curtain and coil the rolling curtain around an outer wall of the barrel,
wherein the substantially similar dimensions of each curved link reduce a size of the coil by reducing a gap between each layer of the coil; and
at least one vertical guide configured to direct a vertical end of the rolling curtain when the rolling is opening or closing.

2. The rolling grille system of claim 1, wherein each curved link further comprises:
a tab linkage extending from a first end of the curved link; and
a notch linkage extending from a second end of the curved link,
wherein the notch linkage includes two tubular sections spaced apart and configured to receive the tab linkage of a second curved link, and
wherein the tab linkage of the curved link couples, using the rod, to the notch linkage of the second curved link.

3. The rolling grille system of claim 2, further comprising:
a shoulder positioned on the first end of the curved link and configured to receive the notch linkage of a third curved linkage,
wherein the shoulder reduces the uniform gap between linkages to decrease the size of the coil.

4. The rolling grille system of claim 2, further comprising:
an arched length extending from the tab linkage to the notch linkage,
wherein the arched length defines a curvature of the curved link.

5. The rolling grille system of claim 4, wherein a radius of the arched length and a radius of the barrel determine the gap between each layer of the coil and an overall diameter of the rolling curtain when the rolling curtain is in a coiled position.

6. The rolling grille system of claim 1, further comprising:
a motor system configured to rotate the barrel,
wherein the motor system is sized based on a size of the rolling grille and a size of the barrel.

7. The rolling grille system of claim 1, further comprising:
a photo eye configured to detect an obstruction in a path of the rolling grille,
wherein a control panel prevents the rolling curtain from closing when the photo eye detects the obstruction, and
wherein the photo eye is positioned at the bottom end of the rolling curtain; and
a monitored light curtain configured to detect an obstruction in the path of the rolling grille,
wherein the monitored light curtain stops and reverses the closing of the rolling grille.

8. The rolling grille of claim 7, further comprising:
a second photo eye configured to detect the obstruction in the path of the rolling curtain,
wherein the control panel prevents the rolling curtain from opening when the second photo eye detects the obstruction, and
wherein the second photo eye is positioned at a top end of the rolling curtain.

9. A rolling grille comprising:
a plurality of curved links, each curved link affixed to an adjacent curved link through a plurality of rods, thereby forming a rolling grille curtain configured to form a tight coil when rolled,
wherein each curved link has substantially similar dimensions to reduce a spacing formed between each layer of the tight coil, and
wherein the curved links cause the rolling grille curtain to have uniform gaps between each curved link; and
a bottom bar attached to a bottom end of the rolling grille curtain,
wherein the bottom bar is configured to add horizontal rigidity to the rolling grille curtain to reduce the spacing between each layer of the tight coil.

10. The rolling grille of claim 9, wherein each curved link further comprises:
a tab linkage extending from a first end of the curved link; and
a notch linkage extending from a second end of the curved link,
wherein the tab linkage of the curved link couples, using the rod, to the notch linkage of a second curved link.

11. The rolling grille of claim 2, further comprising:
a shoulder positioned on the first end of the curved link and configured to receive the notch linkage of a third curved linkage,
wherein the shoulder reduces the uniform gap between linkages to decrease the size of the coil.

12. The rolling grille of claim 10, further comprising:
an arched length extending from the tab linkage to the notch linkage,
wherein the arched length defines a radius of the curved link.

13. The rolling grille of claim 9, further comprising:
a barrel configured to receive the rolling curtain and coil the rolling curtain around an outer wall of the barrel,
wherein the substantially similar dimensions of each curved link reduce a size of the coil by reducing a gap between each layer of the coil; and a motor system configured to rotate the barrel, and
wherein the motor system is sized based on a size of the rolling grille and a size of the barrel.

14. The rolling grille of claim 9, further comprising:
a photo eye configured to detect an obstruction in a path of the rolling grille,
wherein a control panel prevents the rolling grille curtain from closing when the photo eye detects the obstruction, and
wherein the photo eye is positioned at the bottom end of the rolling grille curtain; and
a second photo eye configured to detect the obstruction in the path of the rolling grille,
wherein the control panel prevents the rolling grille curtain from opening when the second photo eye detects the obstruction, and
wherein the second photo eye is positioned at a top end of the rolling grille curtain.

15. A tight coil rolling grille system comprising:
a plurality of curved links, each curved link affixed to an adjacent curved link through a plurality of rods thereby forming a rolling curtain configured to form the tight coil when rolled,
wherein each curved link has substantially similar dimensions to reduce a spacing formed between each layer of the tight coil, and
wherein the curved links causes the rolling curtain to have uniform gaps between each curved link; and
a bottom bar attached to a bottom end of the rolling curtain,
wherein the bottom bar is configured to add horizontal rigidity to the rolling curtain.

16. The tight coil rolling grille system of claim 15, wherein each curved link further comprises:
a tab linkage extending from a first end of the curved link; and
a notch linkage extending from a second end of the curved link,
wherein the tab linkage of the curved link couples, using the rod, to the notch linkage of a second curved link.

17. The tight coil rolling grille system of claim 16, further comprising:
an arched length extending from the tab linkage to the notch linkage,
wherein the arched length defines a radius of the curved link.

18. The tight coil rolling grille system of claim 15, further comprising:
a barrel configured to receive the rolling curtain and coil the rolling curtain around an outer wall of the barrel,
wherein the substantially similar dimensions of each curved link reduce a size of the coil by reducing a gap between each layer of the coil on the barrel.

19. The tight coil rolling grille system of claim 15, further comprising:
a motor system configured to rotate a barrel to open or close the tight coil rolling grille,
wherein the motor system is sized based on a size of the tight coil rolling grille and a size of the barrel, and
wherein the rolling curtain wraps around the barrel when the tight coil rolling curtain is closing.

20. The tight coil rolling grille system of claim 15, further comprising:
at least one photo eye configured to detect an obstruction in a path of the tight coil rolling grille,
wherein a control panel prevents the rolling curtain from opening or closing when the photo eye detects the obstruction.
